(19) United States
(12) Patent Application Publication
(10) Pub. No.: US 2009/0019822 A1
(43) Pub. Date: Jan. 22, 2009

(54) Filter arrangement for a range hood

(75) Inventors: Egon Feisthammel, Rastatt (DE); Udo Reiff, Knittlingen (DE); Dieter Rosmann, Stuttgart (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch Siemens Hausgerate GmbH, Munchen (DE)

(21) Appl. No.: 11/918,819

(22) PCT Filed: Feb. 16, 2006
(86) PCT No.: PCT/EP2006/060008

§ 371 Date: Oct. 17, 2007

(30) Foreign Application Priority Data
Apr. 28, 2005 (DE) 10 2005 019 831.7

(51) Int. Cl. B01D 50/00

(52) U.S. Cl. 55/385.4

(57) ABSTRACT

A filter arrangement for a range hood, which is used for separating at least one of particles and liquid drops from an air flow penetrating the filter arrangement. The filter arrangement includes at least two shells that are disposed one inside the other. The inventive filter arrangement is characterized in that the shells are removably connected to one another such that producing, handling, and cleaning the filter arrangement is simplified.

The invention relates to a filter arrangement for a range hood for separating particles and/or liquid drops from air flowing through the filter arrangement that consists of at least two shells resting one within the other.

Filter arrangements of said type are known from, for instance, DE 197 53 687 A1. The filter arrangement described therein is a conically embodied grease filter made of multi-layer expanded metal. The individual expanded-metal layers are joined in their edge region by means of a disk ring.

A disadvantage of said filter arrangement is that particles consisting of, for instance, dust or gummy oil become deposited within and between the individual expanded-metal layers. A high water pressure and/or high temperatures will therefore be necessary for cleaning said filter arrangement.

A further filter arrangement is described in DE 27 20 201 C2. That filter arrangement is a fat collector grid wherein lamellas are used that are arcuately curved in cross-section and arranged in parallel in a frame in two mutually offset rows and a turbulence in the grid is produced thereby that results in air-borne impurities' being separated off.

The lamellas are rigidly secured in the frame so that the mutually facing inner sides of the lamellas are not accessible from the outside. Said fat collector filter is hence also difficult to clean.

The object of the present invention is to provide a filter arrangement that has a simple structural design and is in particular easy to clean.

Said object is achieved in a filter arrangement of the type cited in the introduction through the shells' being releasably mutually joined.

The shells can be releasably joined by simply placing or inserting one shell into another. The filter arrangement is owing to said releasable joining rendered easier to produce, handle, and clean.

The shells can be produced separately from each other and each given the required geometry during production. A joining step during production such as, for example, the aforementioned attachment of a disk ring and the production thereof can be dispensed with.

Said releasable joining will furthermore also enable the filter arrangement to be cleaned in a simple manner, for example under running water. Because the shells can be separated from each other, a shell's side that in the functioning condition faces another shell will be accessible and can be cleaned. That is not possible in the case of filter layers that are permanently joined to each other.

The shells can moreover be manually separated from each other as well as re-combined by a user of a range hood in which said filter arrangement is employed. The use of tools will not be necessary.

The inventive filter arrangement will also enable a part of the filter arrangement, in particular one of the shells, to be replaced. Thus if one of the shells is damaged or becomes worn after a lengthy period of use, it can be changed without having to replace the entire filter arrangement.

A spacer is preferably provided on at least one of the shells in the filter arrangement. By means of the spacer, between the mutually facing sides of the shells a space can be formed through which the air flow can be guided and in which the cited particles and/or liquid drops, jointly referred to below also as impurities, can be separated off. Owing to the filter arrangement's structural design, a single spacer will suffice that can be provided on one of the shells. The spacer can be a vertical flange on the edge of one of either shells, as a result of which neither the flow conditions nor the flow pattern within the space will be influenced or adversely affected. It is especially preferable for the spacer to be embodied as being integral with one of the shells. Thus the flange can be produced by, for example, bending the top edge of the shell. No components other than the shells will be required as a result of said integral design, and handling and cleaning of the filter arrangement will not be impeded by it.

The shells are made preferably of sheet metal and filter openings are provided in areas of the sheet metal.

Using a sheet metal, for example aluminum or stainless steel, embodied particularly as an enameled sheet metal, as the material for the shells will give them greater stability compared with shells made from an expanded metal. Liquid impurities that have been separated off between the shells can moreover be transported across the sheet-metal material's closed surfaces.

To insure that the liquids can be transported at the appropriate locations, filter openings are provided in each case only in certain areas of the shells. What is referred to as a filter opening is herein an opening that serves to guide air within the filter arrangement and can have various geometries. It can be, for example, an opening through which possibly impurity-laden air penetrates in the form of, for instance, steam or vapor in between adjacent shells, or it can be an opening through which cleaned air can exit from in between the shells. Openings that are provided in shells located between outer shells and allow the passage of air requiring to be cleaned are within the scope of the invention also designated as filter openings. Apart from their enabling the transportation of liquids that have been separated off, said type of filter openings provided in specifiable areas of the sheet metal offer the further advantage of being able to be provided on shell-surface areas against which the flow is strong.

The shells preferably each have at least one lateral wall bent upward from a shell floor, and the filter openings are provided in the shells' lateral walls. An edge extraction will be enabled thereby. Moreover, as the lateral surfaces are oriented inclined toward the floor, liquid that has been separated off will under the force of gravity be directed down the lateral walls toward the floor, where it can be collected or from where it can be transported away. The angle between the lateral walls and the floor of the shell is preferably between 30° and 45°. As the shells are preferably produced as a one piece, the floor and lateral walls then jointly forming a single component, said angle can be set already during production. Orienting of lateral elements while the filter arrangement is being installed in a range hood will be dispensed with.

The filter openings of adjacent shells are preferably mutually offset. An eddy-current filter or, as the case may be, eddy trap is in that way provided by means of the at least two shells. Since, owing to the multi-part structural design, the filter openings can in the present invention be embodied at defined locations and having suitable geometries, the flow conditions developing on or, as the case may be, between the shells can also be set optimally and an enhanced degree of separating achieved thereby. Through the formation of an eddy trap, the dimensions of the filter openings can also be selected as being larger than in the case of conventional filter materials since separating does not actually take place in the filter openings themselves. Clogging of the filter openings with impurities, as occurs in the case of expanded-metal filters where the openings in the expanded metal serve for filtering, can hence to a very large extent be avoided in the inventive filter arrangement.

The filter openings can according to one embodiment be at least in part circular holes or circular perforations. A geometry of said kind is in the case of eddy-current filters produced from shaped elements either not possible or possible only using a substantial number of individual elements. Said geometry can, though, inventively be provided by perforating the shell's sheet-metal material. The production of a suitable geometry is insofar greatly simplified in the case of the invention.

Nozzle geometries can preferably be formed on the edge of the filter openings. The nozzle geometries would in particular be walls projecting along the edge of the respective filter opening out of the plane in which said opening is provided. Apart from providing the relative mutual orientation of the filter openings of different shells, said nozzle geometries can serve to set the required flow pattern within the filter arrangement. The flow within the filter arrangement can be selectively guided by means of the nozzle geometry. When a thus directed jet strikes the adjacent shell, the degree of separating will be increased owing to the greater speed compared with a non-accelerated flow.

The nozzle geometries are preferably integral constituents of the shell's sheet metal. The geometries, or the walls forming them, can be formed from the sheet-metal material while the filter opening is being produced by punching or deep-drawing, or by employing other suitable methods. The nozzle geometries being integral constituents of the sheet metal, the filter arrangement's components will remain limited in number to the number of shells. Neither assembling nor cleaning of the filter arrangement will hence be adversely affected by the nozzle geometry.

The shells can inventively be coated. For example a plastic material or Teflon can be used for coating them because, as described above, the filter openings can be relatively large and there will be no fear of their becoming clogged during the coating process as is the case with expanded metal or perforated plates. Coating will be especially advantageous because the shells' sheet-metal material serves in the inventive filter arrangement also to carry away impurities that have been separated off. That can help separated impurities to flow away. Coating will furthermore render the shells and hence the filter arrangement easier to clean.

The shells are shaped preferably like a truncated pyramid. A square truncated pyramid shape is particularly preferable. A truncated pyramid shape will be especially advantageous for the inventive filter arrangement because the relative mutual positioning of filter openings in the individual shells will owing to the four lateral walls and the corner edges formed between them be predefined in the filter arrangement's assembled condition. The corner edges between a shell's adjacent lateral surfaces will serve as an orientation aid. Additional orientation aids in the form of, for instance, grooves would, on the other hand, have to be provided were the shape a truncated cone. Those can be dispensed with in the case of the preferred structural design.

Moreover, the shells' lateral walls can through being inclined help the liquid to flow when the shape is a truncated pyramid. The surface of the lateral walls which serves as that approached by flowing air is furthermore increased in area thanks to the angle between the lateral walls and the floor of the shell. The separating off of impurities can in that way be further intensified compared with an embodiment having lateral surfaces that are perpendicular to the floor.

In a further embodiment the filter arrangement has three shells. The top and bottom shell therein have nozzle geometries on the filter openings that face each other. Inserted between said two shells is a middle shell in which no nozzle geometries have been formed on the edges of the filter openings provided therein. The filter openings in the top and bottom shell are preferably in that case co-oriented and the filter openings in the middle shell offset relative thereto. The sheet-metal material remaining between the filter openings in the middle shell can therefore serve as a baffle plate for an entering air flow. The degree of separating impurities from the air can be increased with that three-part structural design. The level of constructional effort associated with the filter arrangement having a shell-type structural design will moreover be low since just one extra shell will have to be provided. The mutual orientation of the individual shells' filter openings will again be established while the shells are being produced so that the filter arrangement will be easy to handle and in particular no orienting will be necessary.

The invention is described again below with the aid of the attached figures.

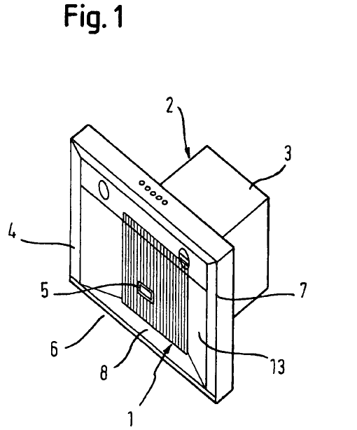

FIG. 1: is a schematic perspective bottom view of a range hood;

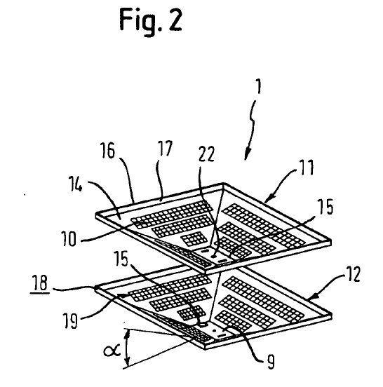

FIG. 2: is a schematic exploded view of an embodiment of the inventive filter arrangement,

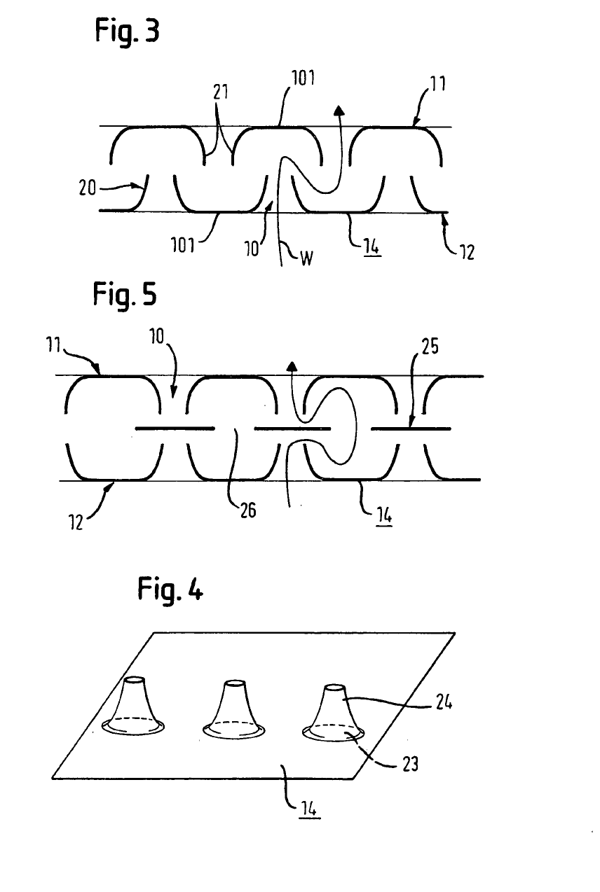

FIG. 3: is a schematic cross-sectional view of a part of a lateral wall of the filter arrangement shown in FIG. 2;

FIG. 4: is a schematic cross-sectional view of an embodiment of the nozzle geometry on a shell in a further embodiment of the filter arrangement; and

FIG. 5: is a schematic cross-sectional view of a lateral wall of a filter arrangement having three shells.

Shown in FIG. 1 is an embodiment of an inventive filter arrangement 1 in the condition when built into a range hood 2. The range hood 2 has a housing 3 and a vapor screen 4 located beneath the housing 3. Provided on the front of the vapor screen 4 are control elements such as, for example, switches 5. Further shown provided on the bottom of the vapor screen 4 are lighting elements 6.

Formed in the bottom of the vapor screen 4 is an extraction opening 7 surrounded by screen plates 8 that run up to the extraction opening 7. Steam or vapor flowing toward the bottom of the vapor screen 4 can be directed thereby toward the extraction opening 7. The extraction opening 7 is covered by the filter arrangement 1.

The filter arrangement 1 has the shape of a square truncated pyramid projecting downward from the edge of the extraction opening 7. In the embodiment shown, a collecting receptacle 13 is secured to the floor 9 of the truncated pyramid. The collecting receptacle 13 can be an oil tray that can be emptied via a fat-drainage faucet (not shown) or removed for emptying. The oil tray's fill level can be indicated by means of a float linked to a scale. It is also possible to provide a fabric mat in the oil tray and replace it with a new one when saturated.

The filter arrangement 1 has the structural design shown in FIG. 2. The filter arrangement 1 consists of a top shell 11 and a bottom shell 12. They are not fastened to each other; instead, the top shell 11 is set into the bottom shell 11. Each of the shells 11, 12 has a floor 9 and four lateral walls 14 contiguous with the edge of the floor 9. The lateral walls 14 are at an angle α, preferably between 30° and 45°, to the floor 9 of the shell 11, 12. The width of the lateral walls 14 increases from their bottom side 15, where they connect to the floor 9, to their top edge 16.

Provided on the top edge 16 of each of the lateral walls 14 is a flange 17. The flanges 17 of the lateral walls 14 of a shell 11, 12 together form one circumferential flange 18 around the top edge of the shells 11, 12.

The circumferential flange 18 runs vertically upward from the top edge 16 of the shell 11, 12. The dimensions of the two shells 11 and 12, in particular the width of the lateral walls 14 and the width and length of the floors 9, are identical in both shells 11, 12. The top shell 11 thus rests at the top edge 16 of the lateral walls 14 of said shell 11 on the flange 18 of the bottom shell 12.

The spacing between the adjacent lateral surfaces 14 of the top shell 11 and bottom shell 12 and between the floors 9 of the top shell 11 and bottom shell 12 is determined by the height of the flange 18. Although a flange 18 is in the embodiment shown also provided on the top shell 11, it can also be embodied as not having a flange, or the flange can be bent downward for improved retention of the top shell 11 on the bottom shell 12.

Applied to the lateral surfaces 14 of the top and bottom shell 11, 12, are slots 10 serving as filter openings. Said slots 10 extend in the longitudinal direction of the lateral surfaces 14, meaning from their top edge 16 to the bottom edge 15. Distributed spaced apart within each lateral surface 14 across the height thereof are three rows 9 of slots 10. The slots 10 are mutually parallel. Owing to the narrowing of the lateral surface 14 toward the floor 9, the number of slots 10 in the three rows 9 reduces from the top to the bottom row. The slots 10 in a row 9 of the top shell 11 have a half-pitch offset from the slots 10 in the corresponding row 9 in the bottom shell 12. That is illustrated schematically in FIG. 3 that shows a schematic cross-section of a filter arrangement 1 consisting of two shells 11, 12.

Nozzle geometries 20 have been punched on the slots 10. Said nozzle geometries 20 are substantially walls 21 which along the edge of the slots 10 project therefrom out of the plane of the lateral wall 14. The nozzle geometries 20 of the top shell 11 and bottom shell 12 face each other but with a half-pitch offset. Thus in FIG. 3 the walls 21 of the top shell 11 project downward and the walls 21 of the bottom shell 12 project upward across the respective lateral wall 14. The transitions from the lateral surface 14 to the walls 21 of the nozzle geometry 20 are radial. Sharp corners can thereby be avoided in which dirt could be deposited and which will be difficult to reach during cleaning.

The space between the top shell 11 and bottom shell 12 is selected so as still to leave a clearance between the nozzle geometry 20 and respective other shell 12, 11 at the end, that of shell 11, 12 on which it is provided. An eddy-current filter or, as the case may be, eddy trap is produced through said arrangement.

Vapor W flowing toward the range hood 2 from below can enter the space formed between the shells 11 and 12 via the slots 10 in the bottom shell 12. Said vapor will have a high speed after exiting the nozzle geometry 20 of the bottom shell 12. It will at said high speed strike the track 101 formed between two slots 10 in the top shell 11. The vapor W will be diverted as a result of its impact and be directed to a track 101 formed between two slots 10 in the bottom shell 12. The jet will impact against that track 101 also and can exit via the slots 10 in the top shell 11. Impurities such as, for instance, fat will be separated from the vapor W as a result of the turbulence and the impact of the vapor W in the filter arrangement.

Said impurities can run along the tracks 101 of the top shell 11 and bottom shell 12 and down the remaining sheet-metal surfaces between the corner edges of the pyramid shape and the slots 10 toward the floor 9. Provided in the floor 9 are drainage openings 22 via which the liquid that has been separated off can be directed into a collecting receptacle 13 or to a removal system (not shown).

The geometry of the nozzles on the filter openings is not restricted to the slot shape illustrated. Thus, for example, circular perforations 23 having a punched nozzle 24 can also be used. A geometry of said type is shown schematically in FIG. 4. It is also possible to combine different passage geometries. Thus circular perforations and slots can be provided in one shell. The corresponding filter openings will then be provided offset in another shell interacting with the first.

FIG. 5 is a schematic cross-sectional view of a part of a lateral wall 14 of a filter arrangement 1 having three shells 11, 12, 25. The top shell 11 and bottom shell 12 have substantially the same structural design as the shells 11, 12 shown in FIG. 2. The slots 10 in the lateral walls 14 of the top shell 11 and bottom shell 12 are, though, in that embodiment oriented opposingly, meaning they are situated one above the other. Slots 26 are likewise provided in the intermediate or middle shell 25. They do not, however, have any nozzle geometries but are cut-outs in the lateral walls 14 of the intermediate shell 25. Said slots 26 are arranged offset from the slots 10.

The vapor W entering the filter arrangement via the slots 10 in the bottom shell 12 will thus on exiting the nozzle geometry 20 impact against the track formed between two slots 26 in the intermediate shell. The vapor W is from there directed toward the top side of the bottom shell 12. The vapor W then passes through the slots 26 and impacts against the bottom side of the top shell 11. It is from there directed toward the top side of the intermediate shell 25 in order from there to exit the filter arrangement through the nozzle geometry 20 of the slots 10 in the top shell 11 and the slots 10 in the top shell 11. The impurities contained in the vapor W will be spun out during its said impacting and the diverting that has taken place. The air exiting the filter arrangement 1 will hence have been cleaned. The separating-off of impurities will owing to the air's impacting against the intermediate shell 25 and the increased number of changes in direction be improved in the case of said three-layer arrangement.

The invention is not restricted to the embodiments illustrated. For example a further filter element such as, for instance, an expanded-metal filter can be located in the filter arrangement downstream of the top shell. Said filter can be emplaced in the top shell and hence likewise have the shape of a truncated pyramid, or the opening in the top shell's truncated pyramid is covered by a plate-shaped filter element. The shells can furthermore have the shape of a truncated cone wherein the filter openings are provided in its casing surface.

The inventive filter arrangement can be expediently employed particularly in range hoods installed above cooking areas at which substantially thin-bodied rather than resinating oils such as, for example, vegetable oils are used. The inventive filter arrangement can furthermore be employed advantageously in regions in which cleaning possibilities are limited owing to a lack of rinsing machines. That is particularly because the inventive filter arrangement has virtually a self-cleaning effect. The liquids that have been separated off can run down the shells' lateral walls and be removed or collected.

1-10. (canceled)

11. A filter arrangement for a range hood, the filter comprising:
at least two shells disposed one within the other, the shells being removably connected to one another and the filter arrangement operating to separate at least one of particles and liquid drops from an air flow flowing through the filter arrangement.

12. The filter arrangement according to claim 11 and further comprising a spacer disposed on at least one of the shells in the filter arrangement.

13. The filter arrangement according to claim 12, wherein the shells are formed from sheet metal and filter openings are formed in portions of the sheet metal.

14. The filter arrangement according to claim 12, wherein the shells are formed with a shell floor and lateral walls extending away from the shell floor and wherein filter openings are formed in the lateral walls of the shells.

15. The filter arrangement according to claim 13, wherein the filter openings of adjacent shells are mutually offset.

16. The filter arrangement according to claim 13, wherein at least a part of the filter openings are circular holes.

17. The filter arrangement according to claim 13 and further comprising at least one nozzle formed on an edge of at least one filter opening.

18. The filter arrangement according to claim 17, wherein the nozzles are integrally formed with the shells.

19. The filter arrangement according to claim 11, wherein the shells are coated with a coating material.

20. The filter arrangement according to claim 11, wherein the shells are each formed as a truncated pyramid.
